(19) United States
(12) Patent Application Publication
(10) Pub. No.: US 2024/0198274 A1
(43) Pub. Date: Jun. 20, 2024

(54) FRAME AND CARTRIDGE FOR SUPPORTING SORBENT ARTICLES IN DIRECT AIR CAPTURE SYSTEMS

(71) Applicant: W. L. Gore & Associates, Inc., Newark, DE (US)

(72) Inventors: Christine M. Scotti, Newark, DE (US); Ryan S. Titone, Flagstaff, AZ (US); Edward H. Cully, Clarksville, VA (US); Regina M. Dell, North East, MD (US)

(21) Appl. No.: 18/544,769

(22) Filed: Dec. 19, 2023

Related U.S. Application Data
(60) Provisional application No. 63/433,954, filed on Dec. 20, 2022.
(60) Provisional application No. 63/611,309, filed on Dec. 18, 2023.

(51) Int. Cl. B01D 53/04

(52) U.S. Cl. CPC B01D 53/0415; B01D 2257/504; B01D 2258/06

(57) ABSTRACT

A direct air capture (DAC) device includes configurations that allow stacking of DAC cartridges to maintain a stacked configuration within a DAC reactor. The DAC cartridges may have a plurality of sorbent articles disposed within the cartridges and the cartridges may be insertable into a frame or supported by the frame.

### CROSS REFERENCE TO RELATED APPLICATIONS

This application claims the benefit of U.S. Provisional Application No. 63/433,954, filed Dec. 20, 2022, and U.S. Provisional Application No. 63/611,309, filed Dec. 18, 2023, the disclosures of which are incorporated herein by reference in their entireties for all purposes.

### FIELD

The present disclosure relates to sorbent material composite articles and structures for supporting the sorbent material composite articles during adsorption and desorption processes for direct air capture (DAC) of carbon dioxide (CO₂).

### BACKGROUND

Increasing carbon dioxide (CO₂) levels associated with greenhouse gas emission are shown to be harmful to the environment. As reported by the Climate.gov article “Climate Change: Atmospheric Carbon Dioxide,” the 2019 average CO₂ level in the atmosphere was 409.8 ppm, the highest level that has been noted in the past 800,000 years. The rate of increase of CO₂ in the atmosphere is also reported to be much higher than the rates in previous decades.

In order to limit climate change to acceptable levels, it is not only necessary to reduce CO₂ emissions in the near future to zero but also to achieve negative CO₂ emissions. Several possibilities exist in order to achieve negative emissions, e.g. combustion of biomaterials for the generation of electricity combined with CO₂ capture from the combustion flue gas and subsequent CO₂ sequestration (also referred to as “bioenergy with carbon capture and storage,” or BECCS) or direct air capture (DAC) of CO₂.

Capturing CO₂ directly from the atmosphere, referred to as DAC, is one of several means of mitigating anthropogenic greenhouse gas emissions and has attractive economic perspectives as a non-fossil, location-independent CO₂ source for the commodity market and for the production of synthetic fuels. The specific advantages of CO₂ capture from the atmosphere include: a) DAC can address the emissions of distributed sources (e.g. vehicles . . . land, sea and air), which account for a large portion of the worldwide greenhouse gas emissions and can currently not be captured at the site of emission in an economically feasible way; b) DAC can address legacy emissions and can therefore create truly negative emissions, and c) DAC systems do not need to be attached to the source of emission but may be location independent and can be located at the site of further CO₂ processing or usage.

There is increasing motivation to develop and improve upon the structures for implementing sorbent material to perform these processes to make them more efficient, such as streamlining the process of replacing old sorbent material with new sorbent material and/or to install sorbent material into different DAC reactors.

### SUMMARY

A direct air capture (DAC) device and methods of controlling the same, as well as method for removing gaseous carbon dioxide from an atmosphere using such devices, are disclosed herein. In one example (“Example 1”), the DAC device includes a DAC device including a DAC cartridge that is stackable to form a stacked configuration, the DAC cartridge having a frame and a plurality of sorbent articles disposed therein and supported by the frame.

In another example (“Example 2”) further to Example 1, the frame has a plurality of faces that are covered using a wall to contain the sorbent articles within the frame.

In another example (“Example 3”) further to Example 2, the frame has an open face through which the sorbent articles are inserted to be disposed within the frame.

In another example (“Example 4”) further to Example 2 or 3, the device further includes a plurality of fastening members with which the wall is attached, affixed, or fastened to the frame.

In another example (“Example 5”) further to Example 4, the fastening members include one or more of: rivets, screws, spot weld material, wire, fiber, or adhesive.

In another example (“Example 6”) further to any one of the preceding Examples, the frame includes a U-shaped structure and a plurality of rods extending across a top portion of the U-shaped structure.

In another example (“Example 7”) further to Example 6, the U-shaped structure is made of a single continuous sheet of material.

In another example (“Example 8”) further to Example 6 or 7, the U-shaped structure includes a plurality of holes or perforations.

In another example (“Example 9”) further to any one of Examples 6-8, a bottom portion of the U-shaped structure includes at least one rounded corner, and the top portion of the U-shaped structure includes at least one flanged upper lip. The rounded corner has a curvature which couples with the flanged upper lip and the rod extending across the top portion of the U-shaped structure.

In one example (“Example 10”), the DAC device includes a first removable cartridge and a first frame. The first frame supports the first removable cartridge and defines a first engagement surface of the first frame. The first engagement surface is disposed on the first frame to define a position of a second engagement surface of a second frame when the second engagement surface is disposed to engage the first engagement surface. The engagement between the first and second engagement surfaces maintains a predetermined distance between the first removable cartridge and a second removable cartridge supported by the second frame.

In another example (“Example 11”) further to Example 10, the device further includes the second removable cartridge and the second frame. The second frame supports the second removable cartridge and defines the second engagement surface that is disposed to engage the first engagement surface of the first frame to maintain the predetermined distance between the first removable cartridge and the second removable cartridge supported by the second frame.

In one example (“Example 12”), the DAC device includes a first frame defining a first engagement surface of the first frame and a second frame. The first frame is configured to support a first cartridge. The second frame defines a second engagement surface of the second frame. The second frame is configured to support a second cartridge. The first and second engagement surfaces, when engaged with each other, maintain a predetermined distance between the first and second cartridges.

In another example (“Example 13”) further to Example 12, the first or second frame is configured to support the first or second cartridge by providing at least one of: (a) a frame rail upon which an edge surface of the first or second cartridge rests, (b) a frame channel through which a projection of the first or second cartridge is disposed, and/or (c) a frame surface that is disposed to support the weight of the first or second cartridge.

In another example (“Example 14”) further to Example 12, the device further includes the first cartridge removably disposed in the first frame, and the second cartridge removably disposed in the second frame.

In another example (“Example 15”) further to any one of Examples 10-14, the predetermined distance is from 1 mm to 5 cm.

In another example (“Example 16”) further to any one of Examples 10-14, the device further includes a plurality of walls supported by the first frame to define at least an interior of the first frame.

In another example (“Example 17”) further to Example 16, the walls include a mesh structure.

In another example (“Example 18”) further to Example 16, the walls include a screen having latticework formed using fibrous materials.

In another example (“Example 19”) further to any one of Examples 10-14, the first frame defines another first engagement surface of the first frame. The device further includes a third frame defining a third engagement surface and configured to support a third cartridge. The third engagement surface and the another first engagement surface, when engaged with each other, maintain another predetermined distance between the first and third cartridges.

In another example (“Example 20”) further to Example 19, the third frame is configured to support the third cartridge by providing at least one of: (a) a frame rail upon which an edge surface of the third cartridge rests, (b) a frame channel through which a projection of the third cartridge is disposed, and/or (c) a frame surface that is disposed to support the weight of the third cartridge.

In another example (“Example 21”) further to Example 19, the device further includes the third cartridge removably disposed in the third frame.

In another example (“Example 22”) further to Example 19, the another predetermined distance is the same as the predetermined distance.

In another example (“Example 23”) further to Example 19, the first frame defines yet another first engagement surface of the first frame. The device further includes a fourth frame defining a fourth engagement surface and configured to support a fourth cartridge. The fourth engagement surface and the yet another first engagement surface, when engaged with each other, maintain yet another predetermined distance between the first and fourth cartridges.

In another example (“Example 24”) further to Example 23, the fourth frame is configured to support the fourth cartridge by providing at least one of: (a) a frame rail upon which an edge surface of the fourth cartridge rests, (b) a frame channel through which a projection of the fourth cartridge is disposed, and/or (c) a frame surface that is disposed to support the weight of the fourth cartridge.

In another example (“Example 25”) further to Example 23, the device further includes the fourth cartridge removably disposed in the fourth frame.

In another example (“Example 26”) further to Example 23, the yet another predetermined distance is the same as one or more of the predetermined distance or the another predetermined distance.

In one example (“Example 27”), the DAC device includes a first cartridge and a first frame. The first frame has opposing walls defining a first cartridge compartment disposed between the opposing walls. Each opposing wall includes a sliding surface facing the first cartridge compartment. The first cartridge is slidably disposed within the first cartridge compartment.

In one example (“Example 28”), the DAC device includes a first frame and a second frame. The first frame has first opposing walls defining a first cartridge compartment disposed between the first opposing walls. The first opposing walls have internal surfaces defining a slidable engagement configured to support a first cartridge in the first cartridge compartment. The second frame has second opposing walls defining a second cartridge compartment disposed between the second opposing walls. The second opposing walls have internal surfaces defining a slidable engagement configured to support a second cartridge in the second cartridge compartment. The first and second frames, when engaged with each other, maintain a predetermined distance between the first and second cartridges.

In another example (“Example 29”) further to Example 28, the first or second frame is configured to support the first or second cartridge by providing at least one of: (a) a frame rail upon which an edge surface of the first or second cartridge rests, (b) a frame channel through which a projection of the first or second cartridge is disposed, and/or (c) a frame surface that is disposed to support the weight of the first or second cartridge.

In another example (“Example 30”) further to Example 28, the device further includes the first cartridge removably disposed in the first cartridge compartment of the first frame, and the second cartridge removably disposed in the second cartridge compartment of the second frame.

In another example (“Example 31”) further to any one of Examples 28-30, the predetermined distance is from 1 mm to 5 cm.

In another example (“Example 32”) further to any one of Examples 27-31, the opposing walls comprise a mesh structure.

In another example (“Example 33”) further to any one of Examples 27-31, the opposing walls comprise a screen having latticework formed using fibrous materials.

In another example (“Example 34”) further to any one of Examples 27-30, the device further includes a third frame having third opposing walls defining a third cartridge compartment disposed between the third opposing walls. The third opposing walls have internal surfaces defining a slidable engagement configured to support a third cartridge in the third cartridge compartment.

In another example (“Example 35”) further to Example 34, the third frame is configured to support the third cartridge by providing at least one of: (a) a frame rail upon which an edge surface of the third cartridge rests, (b) a frame channel through which a projection of the third cartridge is disposed, and/or (c) a frame surface that is disposed to support the weight of the third cartridge.

In another example (“Example 36”) further to Example 34, the device further includes the third cartridge removably disposed in the third cartridge compartment of the third frame. The first and third frames, when engaged with each other, maintain another predetermined distance between the first and third cartridges.

In another example (“Example 37”) further to Example 36, the another predetermined distance is the same as the predetermined distance.

In another example (“Example 38”) further to Example 36, the device further includes a fourth frame and a fourth cartridge. The fourth frame has fourth opposing walls defining a fourth cartridge compartment disposed between the fourth opposing walls. The fourth opposing walls have internal surfaces defining a slidable engagement configured to support a fourth cartridge in the fourth cartridge compartment. The fourth cartridge is removably disposed in the fourth cartridge compartment of the fourth frame. The first and fourth frames, when engaged with each other, maintain yet another predetermined distance between the first and fourth cartridges.

In another example (“Example 39”) further to Example 38, the fourth frame is configured to support the fourth cartridge by providing at least one of: (a) a frame rail upon which an edge surface of the fourth cartridge rests, (b) a frame channel through which a projection of the fourth cartridge is disposed, and/or (c) a frame surface that is disposed to support the weight of the fourth cartridge.

In another example (“Example 40”) further to Example 38, the yet another predetermined distance is the same as one or more of the predetermined distance or the another predetermined distance.

In one example (“Example 41”), the method for removing gaseous carbon dioxide from an atmosphere includes: receiving information about a dispersion of a first quantity of gaseous carbon dioxide into the atmosphere at a first location; initiating a method of separating a second quantity of gaseous carbon dioxide from the atmosphere at a second location, the second quantity being at least a portion of the first quantity, where the method of separating includes the use of the device of any one of Examples 1-40; and initiating a reporting of data regarding the second quantity.

In one example (“Example 42”), the method for removing gaseous carbon dioxide from an atmosphere includes: receiving information about a first quantity of gaseous carbon dioxide; separating a second quantity of gaseous carbon dioxide from the atmosphere, the second quantity being at least a portion of the first quantity, where the method of separating includes the use of the device of any one of Examples 1-40; and reporting data regarding the second quantity.

In one example (“Example 43”), the method for removing gaseous carbon dioxide from an atmosphere includes: transmitting information about a dispersion of a first quantity of gaseous carbon dioxide into the atmosphere at a first location; requesting initiation of a method of separating a second quantity of gaseous carbon dioxide from the atmosphere at a second location, the second quantity being at least a portion of the first quantity, where the method of separating includes the use of the device of any one of Examples 1-40; and receiving a reporting of data regarding the second quantity.

In one example (“Example 44”), the method for removing gaseous carbon dioxide from an atmosphere includes: receiving, from a computing device, a first electronic communication comprising information about a dispersion of a first quantity of gaseous carbon dioxide into the atmosphere at a first location; initiating a separating, by a carbon capture device, of a second quantity of gaseous carbon dioxide from the atmosphere at a second location, the second quantity being at least a portion of the first quantity, where the carbon capture device is the device of any one of Examples 1-40; and initiating a reporting of data associated with the carbon capture device regarding the second quantity, where the data forms part of a second electronic communication.

In another example (“Example 45”) further to Example 44, the second electronic communication is configured to be transmitted to the computing device.

In another example (“Example 46”) further to Example 44 or 45, the second electronic communication is configured to be transmitted to an additional computing device.

In one example (“Example 47”), the method for removing gaseous carbon dioxide from an atmosphere includes: receiving, from a computing device, a first electronic communication comprising information about a first quantity of gaseous carbon dioxide; separating, by a carbon capture device, a second quantity of gaseous carbon dioxide from the atmosphere, the second quantity being at least a portion of the first quantity, where the carbon capture device is the device of any one of Examples 1-40; and reporting, as a second electronic communication, data associated with the carbon capture device regarding the second quantity.

In another example (“Example 48”) further to Example 47, the second electronic communication is configured to be transmitted to the computing device.

In another example (“Example 49”) further to Example 47 or 48, the second electronic communication is configured to be transmitted to an additional computing device.

In another example (“Example 50”) further to method for removing gaseous carbon dioxide from an atmosphere includes: transmitting, to a computing device, a first electronic communication comprising information about a dispersion of a first quantity of gaseous carbon dioxide into the atmosphere at a first location; requesting a separating, by a carbon capture device, of a second quantity of gaseous carbon dioxide from the atmosphere at a second location, the second quantity being at least a portion of the first quantity, where the carbon capture device is the device of any one of Examples 1-40; and receiving a second electronic communication comprising an indication of a reporting of data associated with the carbon capture device regarding the second quantity.

In another example (“Example 51”) further to Example 50, the second electronic communication is received from the computing device.

In another example (“Example 52”) further to Example 50 or 51, the second electronic communication is received in response to transmitting the first electronic communication.

In one example (“Example 53”), the method for removing gaseous carbon dioxide from an atmosphere includes: receiving information about a dispersion of a first quantity of gaseous carbon dioxide into the atmosphere at a first location; initiating a separating of a second quantity of gaseous carbon dioxide from the atmosphere at a second location, the second quantity being at least a portion of the first quantity, where the separating includes the use of the device of any one of Examples 1-40 and initiating a reporting of data regarding the second quantity.

In one example (“Example 54”), the method for removing gaseous carbon dioxide from an atmosphere includes: transmitting information about a dispersion of a first quantity of gaseous carbon dioxide into the atmosphere at a first location; requesting a separating a second quantity of gaseous carbon dioxide from the atmosphere at a second location, the second quantity being at least a portion of the first quantity, where the separating includes the use of the device of any one of Examples 1-40; and receiving a reporting of data regarding the second quantity.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is an illustration of a direct air capture (DAC) device with a single cartridge as viewed from an angle, with the sorbent articles disposed therein, according to embodiments disclosed herein.

FIG. 2 is an illustration of a DAC device with multiple cartridges in a stacked configuration as viewed from an angle, with the sorbent articles disposed therein, according to embodiments disclosed herein.

FIG. 3A is an illustration of an empty cartridge for a DAC device as viewed from an angle, according to embodiments disclosed herein.

FIG. 3B is an enlarged view of a portion of the empty cartridge of FIG. 3A as viewed from an angle, according to embodiments disclosed herein.

FIG. 4 is an illustration of an empty cartridge for a DAC device as viewed from the side, according to embodiments disclosed herein.

FIG. 5 is an illustration of a partial framework of a cartridge for a DAC device as viewed from an angle, according to embodiments disclosed herein.

FIG. 6 is an illustration of a partial framework of a cartridge for a DAC device as viewed from an angle, according to embodiments disclosed herein.

FIG. 7 is an illustration of a cartridge using the framework of FIG. 5 as viewed from an angle, according to embodiments disclosed herein.

FIG. 8A is an illustration of multiple cartridges of FIG. 7 in a stacked configuration as viewed from an angle, according to embodiments disclosed herein.

FIG. 8B is an enlarged view of a portion of the cartridges in the stacked configuration of FIG. 8A as viewed from the side, according to embodiments disclosed herein.

FIG. 9 is a schematic diagram of a multi-phase process for adsorption and desorption having directions of fluid transport shown with respect to a sorbent assembly, according to embodiments disclosed herein.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

Furthermore, the term “direct air capture (DAC) device” is defined to include examples with a single DAC cartridge and with multiple DAC cartridges (in a stacked configuration, for example, as further explained herein). The term “DAC cartridge” may include a single frame (with any suitable framework defining the shape and size of the structure, as further explained herein) that is at least partially filled with sorbent material composite article(s) and can be used for capturing CO₂ directly from the atmosphere. A DAC device may also be referred to as a carbon capture device capable of carrying out any method for separating gaseous CO₂ from a gas mixture in the form of ambient air. It should be appreciated that a DAC device, a single DAC cartridge, and multiple DAC cartridges may each include a cartridge that holds sorbent material without a frame, a cartridge that holds sorbent material with a portion of a frame that provides structural support to the cartridge, and a cartridge that holds sorbetn with a connected frame that structurally supports the cartridge.

### DESCRIPTION OF VARIOUS EMBODIMENTS

The present disclosure relates to devices for use in direct air capture (DAC) to adsorb and separate one or more desired substances from a source stream, such as carbon dioxide (CO₂) from a dilute feed stream, such as air. Such DAC devices may also be used in other adsorbent methods and applications. These methods include, but are not limited to, adsorption of substances from various inputs, including other gas feed streams (e.g., combustion exhaust) and liquid feed streams (e.g., ocean water). The adsorbed substance is not limited to CO₂. Other adsorbed substances may include, but are not limited to, other gas molecules (e.g., N₂, CH₄, and CO), liquid molecules, and solutes. In certain embodiments, the input may be dilute, containing on the order of parts per million (ppm) of the adsorbed substance.

An example of articles and techniques for DAC includes using an article including a substrate such as a monolith that can support or be coated with a sorbent material. Variations are established by changing the type of substrate and the sorbent that is used. However, these previously established articles and methods present limitations in the ability to efficiently cycle between adsorbing and desorbing states. They also have limitations with respect to the energy required to perform the process.

Many times, swing adsorption is a very energy intense process. Whether Pressure Swing, Temperature Swing or Moisture Swing, energy is needed during many of the phases of operation.

As an example, in Temperature-Vacuum Swing Adsorption (TVSA) for Direct Air Capture (DAC) of CO₂, the adsorption step may require fans to force large volumes of air through an air contactor, such as ceramic monolith or plate-pack having a series of adjacent plates with a spacing therebetween. At a point when the operator deems it useful to begin desorption (usually when the contactor has adsorbed an amount of CO₂), the fans may be turned off or deactivated to terminate the adsorption phase.

Once the adsorption phase terminates, the inlet and outlet of the module are closed, which provides a seal for negative pressure. Next, vacuum may be applied to evacuate air within the module and steam is applied to increase the temperature to the point where the sorbent releases CO₂. This CO₂ is then pumped out of the module space and is further processed to remove humidity. Of the aforementioned processes, the desorption step requires significant energy to heat and then cool the module. During desorption, the temperature in the entire module volume must be increased from ambient (which, depending on geographic location, may be extremely cold) to the temperature which facilitates CO₂ removal from the sorbent. In many cases steam is used for this increase in temperature since steam is efficient at transferring heat to a substance. An object of the present invention is to increase the efficiency of a DAC system by providing a module which is capable of variable volume. As an example, the air contactor or module may have one volume during the adsorption step which allows air to flow through it at a very low pressure, thereby facilitating adsorption of CO₂ and at least a second, reduced volume during the desorption step which provides an energy savings by reducing the amount of volume that needs to be increased in temperature. Reducing the volume will also reduce the energy required to apply negative pressure, although in some cases the negative pressure maybe the force that causes the volume reduction.

Similarly, in moisture swing and pressure swing adsorption processes, it is the desorption step that is typically the most energy intensive. In moisture swing, energy used in moving moisture to the contactor and energy used in drying the contactor once the CO₂ is desorbed from it. In pressure swing, energy is used to apply pressure to the sorbent to cause the CO₂ to release from it. In both cases it may also be beneficial to provide an air contactor or module which is capable of variable volume configurations. Current state air contactors and modules are deficient in this respect.

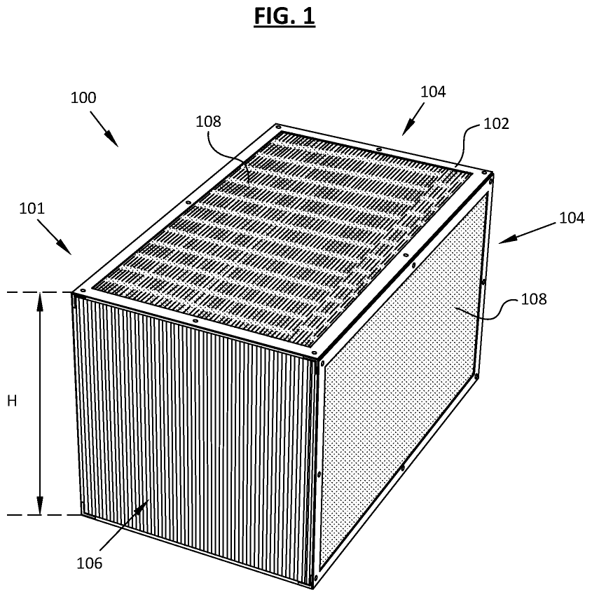

FIG. 1 shows a DAC device 100 according to an example disclosed herein. The DAC device 100 is a carbon capture device which includes a plurality of sorbent material composite articles 106 capable of facilitating adsorption and desorption of one or more components of a feed stream (not shown) during each cycle of adsorption and desorption. The feed stream may be the air passing through the DAC device, and the one or more components may include CO₂ or any other aforementioned gas molecules, for example. In some examples, desorbing the articles 106 may include submerging the articles 106 into a desorption source such as water (or alternatively using steam or heat as the desorption source in some examples) in order to desorb the CO₂.

The articles 106 may be held in place within the DAC device 100 (also referred to herein as a DAC assembly) using a frame 102, a support framework, or a frame structure which includes a plurality of faces 104 through which fluid such as desorbing media which is allowed to pass through during the adsorption/desorption processes as explained above. The desorbing media as referred to herein may include one or more of: hot liquid, steam, saturated steam, superheated liquid, or any substance that transfers heat, etc., as further disclosed in U.S. application Ser. No. 18/234,014 (W. L. Gore & Associates, Inc.), the disclosure of which is incorporated herein by reference in its entirety for all purposes. The DAC device 100 includes a DAC cartridge 101. The height “H” of the DAC cartridge 101 may depend upon the total number of cartridges which may be implemented to form the DAC device or DAC assembly which is to be contained or implemented inside any suitable DAC reactor (not shown). The articles 106 may be inserted or disposed in and supported by the frame 102 to form the DAC cartridge 101, which may be installed in the DAC reactor, in any suitable configuration as further explained herein. In some examples, the frames 102 may be provided to support the DAC cartridge 101 using for example at least one of the following: (a) a frame rail upon which an edge surface of the articles or cartridge may rest, (b) a frame channel through which a projection of the articles or cartridge may be disposed, and/or (c) a frame surface that is disposed to support the weight of the articles or cartridge. In further examples, the support of DAC cartridge 101 provided by the frame 102 and/or the engagement between an article or cartridge 101 and the supporting frame 102 may include a sliding support or engagement, may include a capacity for the article or cartridge 101 to be slid into and out of the frame 102 to provide increased access to the article or cartridge or to inspect the article or cartridge, and may include a selective locking function or a movement inhibitor device that may be engaged to prevent movement between the frame 102 and the supported article or cartridge 101 when desired. The DAC reactors as referred to herein may include those as further disclosed in International Publication Nos. WO 2021/239747 (Climeworks AG) and WO 2023/104656 (Climeworks AG), the disclosures of which are incorporated herein by reference in its entirety their entireties for all purposes.

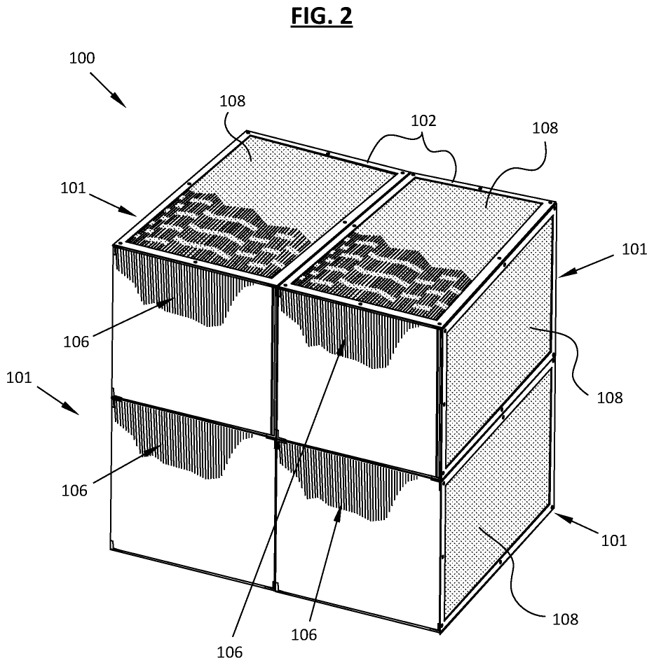

The frame 102 may define a plurality of faces 104 that are each defined by a wall 108 disposed to form each face 104. The wall 108 may be a filter, screen, or mesh configuration having a plurality of openings passing through the wall 108, may be a continuous wall configuration with a series of passages passing through the wall formed by circular or irregular holes through the wall 108 or by deformations in the wall such as louvres, and may be a combination of a solid wall portion with no passages or holes therethrough and a permeable portion with passages or holes therethrough. In some examples, the wall 108 may be a screen having latticework formed using fibrous materials. In a preferred embodiment illustrated in FIG. 1, portions of the frame 102 support each wall 108, with each wall 108 being a mesh with passages allowing fluidic communication between the interior of the cartridge 101 and the surrounding reactor environment or adjacent cartridges 101 that may be disposed in a stack configuration as illustrated in FIG. 2. In an example, when the frame 102 is a rectangular prism as illustrated in FIG. 1, four (4) of the total of six (6) faces 104 in the rectangular prism may have walls 108 such that the articles 106 may be inserted into the interior or internal volume of the frame 102 through the two (2) open faces that do not have walls 108. In such examples, the “edges” of the rectangular prism are defined by the frame 102. In some examples, only one (1) face may be open and not covered with the wall 108, so as to provide additional protection for the articles 106. The wall 108 may assist in containing the articles 106 while allowing desorbing media to pass through. In some examples, the wall 108 may include a mesh, a combination of meshes, or a meshed structure. In some examples, the wall 108 may include fibrous and/or membranous materials. In some examples, a cross-section of the DAC cartridge 101 may resemble a parallelogram, a rectangle, a square, or any other suitable polygon. In some examples, the height H of each cartridge may be about 180 mm. In some examples, the height H may be from 100 mm to 200 mm, from 200 mm to 300 mm, from 300 mm to 500 mm, from 500 mm to 700 mm, from 700 mm to 1 m, from 1 m to 1.5 m, from 1.5 m to 2 m, or any other suitable range there between, which may vary according to the various sizes and internal structures of the DAC reactor in which the DAC cartridges are to be installed. In some examples, the frame 102 may also include one or more rails upon which an edge surface of the articles 106 or cartridge 101 may rest. In some examples, the frame 102 may also include a frame channel through which a projection of the articles 106 or cartridge 101 may be disposed. In some examples, the frame 102 may also include a frame surface that is disposed to support the weight of the articles 106 or cartridge 101.

FIG. 2 shows multiple DAC cartridges 101 (each of which may be the cartridge 101 as shown in FIG. 1, for example) that are stackable to form a stacked configuration in a multi-cartridge DAC device. The DAC device 100 includes multiple cartridges 101, each having a frame 102, wall 108, and sorbent articles 106 installed therein. Each cartridge 101 is stackable on top of, as well as side-by-side with, another cartridge 101 with same or similar size, shape, and/or form (e.g., similar dimensions) in forming the multi-cartridge structure or assembly for the DAC device 100, which may be placed inside the DAC reactor. As can be appreciated, the stacked configuration of cartridges is preferably mechanically stable and capable of maintaining the stacked configuration throughout the cycling of the DAC process. The stacked configuration may include arrangements where adjacent cartridges are mechanically and/or slidably coupled with each other (in a mechanical engagement and/or a slidable engagement, respectively) to maintain the stacked configuration, and may further include a reversable coupling engagement that allows adjacent cartridges to be coupled to each other when desired and to be decoupled to allow repositioning of the cartridges in the stacked configuration.

In some examples, each cartridge 101 may contain a different type of sorbent material (in the sorbent articles 106) from one or more other cartridges 101. In some examples, the sorbent articles 106 may be formed in the shape of a sheet or a thin board or sorbent material which may be flexible or rigid and can be inserted into the frame 102 to form the DAC cartridge 101, for example as further disclosed in International Publication Nos. WO 2022/187730 (W. L. Gore & Associates, Inc.) and WO 2022/187733 (W. L. Gore & Associates, Inc.), the disclosures of which are incorporated herein by reference in their entireties for all purposes. In some examples, each cartridge 101 may have such sorbent sheets arranged differently from one or more other cartridges 101. In some examples, the spacing between adjacent sorbent articles 106 may be different for one or more of the cartridges 101, for example in order to accommodate the different airflow patterns within the DAC reactor. In some examples, different numbers and stacking configuration of the multiple cartridges 101 may be implemented according to the size or inner dimension of the DAC reactor.

In some examples, the individual DAC cartridges 101 may be removed from the multi-cartridge DAC device 100 and replaced with another cartridge 101, for example when replacing the old sorbent material(s) contained inside the DAC cartridge 101 with new sorbent material(s). The removing and replacing of a DAC cartridge 101 may be performed without removing the entire DAC device 100 from inside the DAC reactor, such that if only one cartridge needs to be removed, it may be removed (and subsequently replaced) without affecting one or more of the other cartridges that form the multi-cartridge DAC device 100. The removal of a cartridge 101 from the DAC device 100 may involve a decoupling or disengagement from the stack configuration and/or a sliding engagement between the cartridge 101 and the frame 102. In the example shown, the total height of the DAC device 100 may be 360 mm so as to be sized for a 36 cm reactor, although the DAC device may be alternatively scaled as suitable for larger or smaller reactors that are known in the art. Also, although only four (4) cartridges are shown in FIG. 2, it is to be understood that any number of cartridges may be installed or implemented as suitable for the DAC reactor.

The sorbent material as referred to herein may include any suitable carbon dioxide adsorbing material which may include, but is not limited to, an ion exchange resin (e.g., a strongly basic anion exchange resin such as Dowex™ Marathon™ A resin available from Dow Chemical Company), zeolite, activated carbon, alumina, metal-organic frameworks, polyethyleneimine (PEI), or another suitable carbon dioxide adsorbing material, such as desiccant, carbon molecular sieve, carbon adsorbent, graphite, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, ETS, CTS, metal oxide, chemisorbent, amine, organo-metallic reactant, hydrotalcite, silicalite, zeolitic imidazolate framework and metal organic framework (MOF) adsorbent compounds, and combinations thereof, for example as further disclosed in U.S. application Ser. No. 18/199,506 (W. L. Gore & Associates, Inc.), the disclosure of which is incorporated herein by reference in its entirety for all purposes.

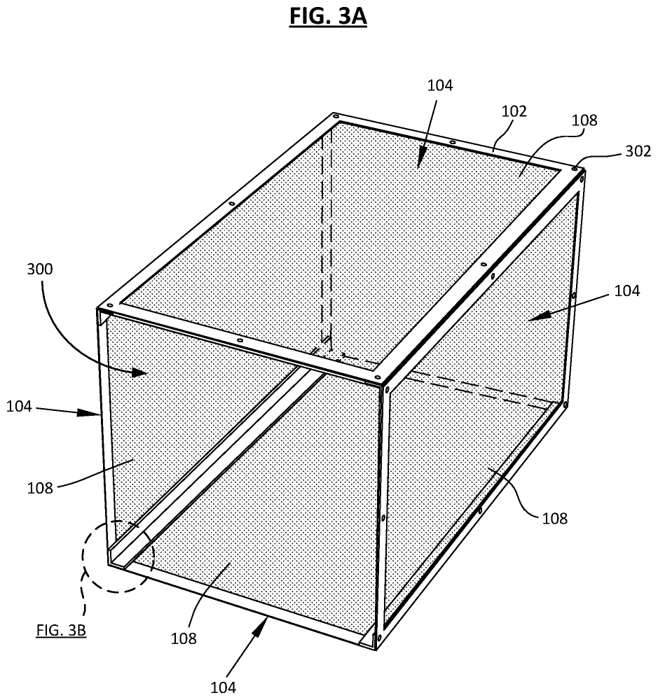

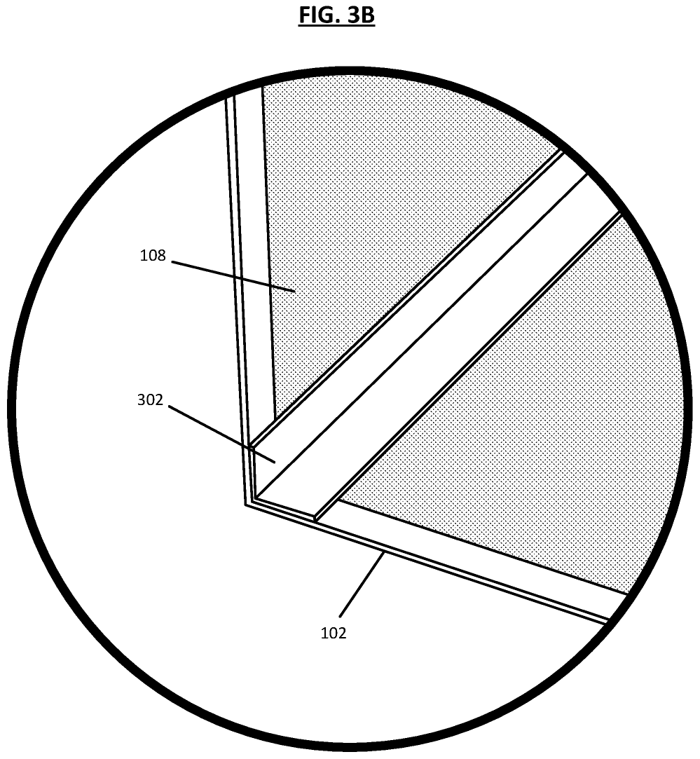

FIGS. 3A and 3B show an example of the frame 102 with the wall 108 covering some of the faces 104 of the structure 102. Note that the illustrated front face is not covered by any filter so as to provide an access point for the sorbent articles in the form of an open face 300 (or a plurality of open faces, as appropriate) in the frame 102. In some examples, the open face 300 may at least partially define, or further include, a frame channel through which a projection of the articles 106 or cartridge 101 may be disposed. In some examples, the frame 102 may be formed using a plurality of frame components that are attached, affixed, or fastened together. The frame 102 may include a plurality of fastening members 302 which may include, but are not limited to, rivets, screws, spot weld material, wire or fiber, and/or adhesive, for example, in order to retain the structural integrity of the frame 102. The fastening members 302 may also be disposed or utilized to attach, affix, or fasten the wall 108 to the frame 102. In some examples, some of the fastening members 302 may be disposed on the inside of the frame 102 as shown in FIG. 3B. In some examples, the fastening members 302 may be formed as, or further include, frame rails upon which an edge surface of the articles 106 or cartridge 101 may rest.

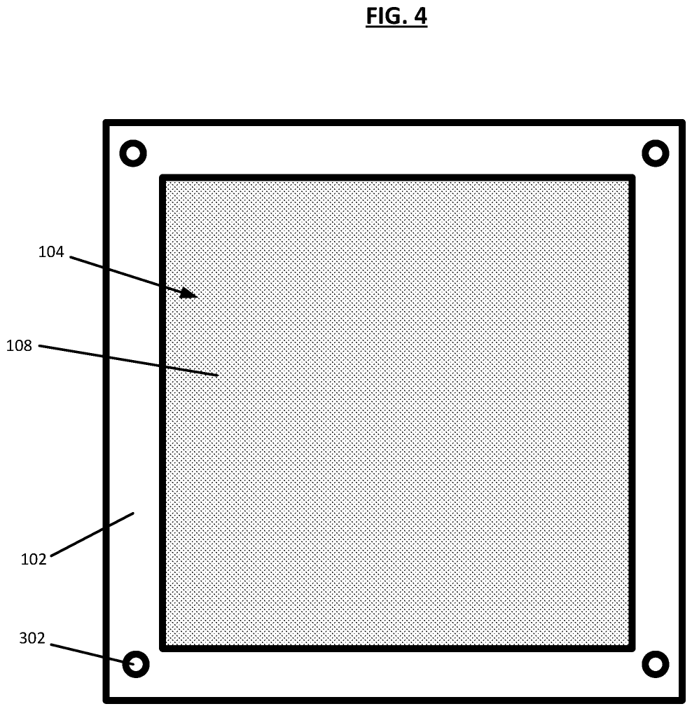

FIG. 4 shows the frame 102 with a face 104 that is covered with the wall 108. The wall 108 may be a separate component (for example having its own support structure or framework) that is attached, affixed, or fastened to the frame 102 using the fastening members 302, or the wall 108 may be disposed between frame 102 in a floating arrangement bounded by supporting frame 102 components that allows the wall 108 to move slightly as permitted by the surrounding frame 102 or fastening members 302. The filter or filter component may be supported by a frame which may be square or any other suitable shape such as rectangular, circular, ovular, polygonal, etc. The wall 108 may be configurable to achieve different results. For example, the wall 108 that is implemented in one DAC cartridge 101 may have different physical properties from the filter implemented in another DAC cartridge. The physical properties may include the size of the openings in the filter, the thickness of the filter, the weight of the filter, the durability of the filter, the rigidity or flexibility of the filter, or any other properties which may affect the performance of the DAC cartridge. In some examples, the filters of different DAC cartridges may be made of different materials.

The wall 108 may be formed using any suitable material such as expanded polytetrafluoroethylene (ePTFE), expanded polyethylene (ePE), polytetrafluoroethylene (PTFE), or any other suitable porous material. For example, the porous material may be rigid or flexible, for example ceramic, cellulose, or carbon fiber, etc. In some examples, the porous material may be a porous polymer. It will be appreciated that non-woven materials such as nanospun, meltblown, spunbond and porous cast films could be among the various other suitable porous polymer forms. The wall 108 may be expanded by stretching the material at a controlled temperature and a controlled stretch rate, causing the material to fibrillate. Following expansion, the wall 108 may comprise a microstructure of a plurality of nodes and a plurality of fibrils that connect adjacent nodes to include pores bordered by the fibrils and the nodes. An exemplary node and fibril microstructure is described in U.S. Pat. No. 3,953,566 (W. L. Gore & Associates, Inc.), incorporated herein by reference in its entirety. The pores of the wall 108 may be considered micropores. Such micropores may have a single pore size or a distribution of pore sizes. The average pores size may range from 0.1 microns to 100 microns in certain embodiments.

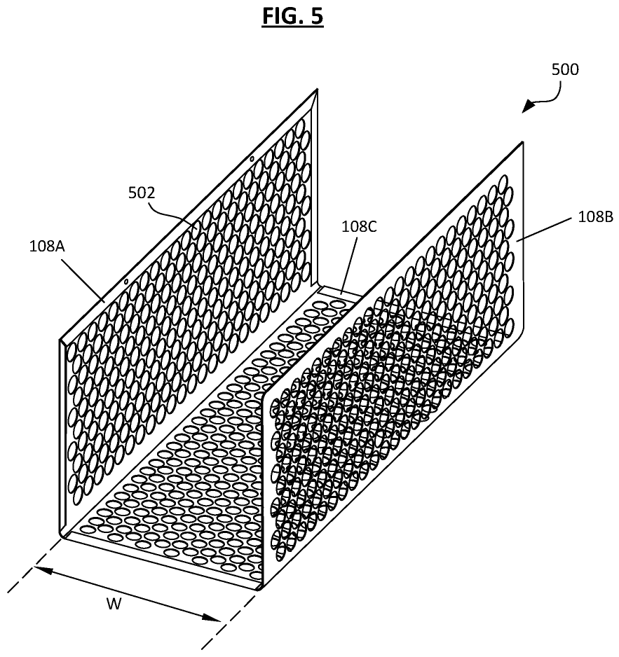

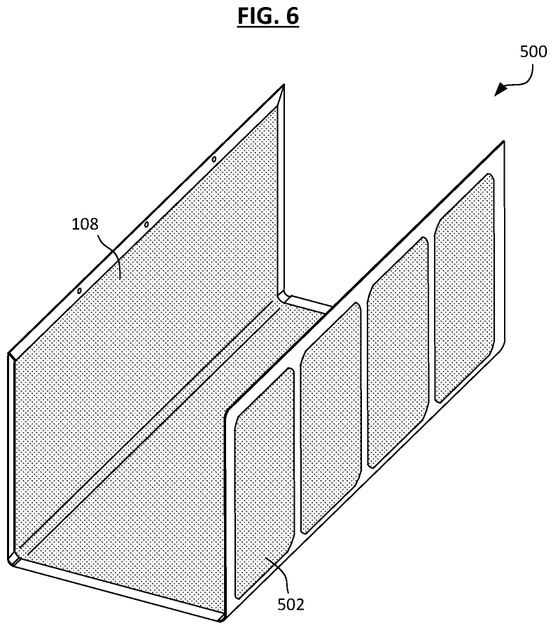

FIGS. 5 and 6 show a support structure 500 that is U-shaped (having two opposing verticals walls 108A and 108B held in a parallel arrangement by an interposed horizontal wall 108C therebetween to define a letter “U” configuration when viewed from one end), which may be part of (or a subcomponent of) the frame 102 in some examples disclosed herein. In some examples, at least a portion of the support structure or the walls (such as the interposed horizontal wall 108C) may at least partially define a frame surface that is disposed to support the weight of the articles 106 or cartridge 101. The space or the internal surfaces of the frame 102 disposed between the opposing walls 108A and 108B defines a compartment for a DAC cartridge 101, such that the sorbent articles 106 of the cartridge 101 may be slidably disposed in the compartment, also referred to as a cartridge compartment. The U-shaped structure 500 may be made of a single continuous sheet of material such as metal (including but not limited to aluminum to provide low thermal mass for the cartridge 101 while occupying minimal cross-sectional area, for example) or plastic/polymer. In a single continuous sheet configuration, the single continuous sheet is bent or undergoes a permanent deformation in such a way to provide a shape resembling an angled U-shaped configuration. The corners of the U-shaped structure 500 in some examples may be curved or rounded for structural integrity or to avoid the creation of corners that may damage adjacent structures. In some examples, the metal forming the U-shaped structure 500 may include but not be limited to aluminum and steel.

In FIG. 5, the U-shaped structure 500 has walls 108 with a plurality of holes or perforations 502 through which fluid such as the desorbing media may be allowed to pass. In some examples, the U-shaped structure 500 is free of any filter or mesh component(s) because the perforations 502 allow fluid to pass therethrough while the unperforated portions of the U-shaped structure 500 function to hold the sorbent articles 106 that are disposed therein. In some examples, the perforations 502 are circular, ovular, or polygonal in shape, as suitable. In some examples, the perforations 502 have a maximal cross-sectional length (or diameter if the perforations are circular) of from 1 to 5 mm, from 5 mm to 10 mm, from 10 mm to 15 mm, from 15 mm to 20 mm, or any other suitable value or range therebetween. In some examples, the maximal cross-sectional length of each perforation 502 may be from 1% to 5%, from 5% to 10%, from 10% to 15%, from 15% to 20%, or any other suitable value or range therebetween with respect to the width “W” of the cartridge. The holes or perforations 502 in any such examples may be differently shaped to optimize cross-sectional area for crossflow of fluid.

In FIG. 6, the individual perforations 502 are smaller in size as compared to FIG. 5 but occupy a greater area of the wall surfaces of the U-shaped structure 500 in FIG. 6 than the perforations 502 of the example shown in FIG. 5. In some examples, the maximal cross-sectional length of a perforation 502 may be from 20 mm to 25 mm, from 25 mm to 30 mm, from 30 mm to 35 mm, from 35 mm to 40 mm, or any other suitable value or range therebetween. In some examples, the maximal cross-sectional length of each perforation 502 may be from 20% to 25%, from 25% to 30%, from 30% to 35%, from 35% to 40%, from 40% to 50%, from 50% to 60%, from 60% to 70%, from 70% to 80%, from 80% to 90%, or any other suitable value or range therebetween with respect to the width “W” of the cartridge. In some examples, the combined surface area occupied by all the perforations 502 within a wall 108 or a portion of a wall 108 may occupy at least 50%, at least 60%, at least 70%, at least 80%, or at least 90%, but less than 100%, of the total surface area of the wall 108 defining the respective perforations 502 of the structure 500. Additionally, the U-shaped structure 500 of FIG. 6 may include a wall 108 that lines the internal portion of the U-shaped structure 500 to hold the sorbent articles 106 that are disposed therein. The wall 108 may be included to provide crossflow benefits as well as to simplify the manufacturing process.

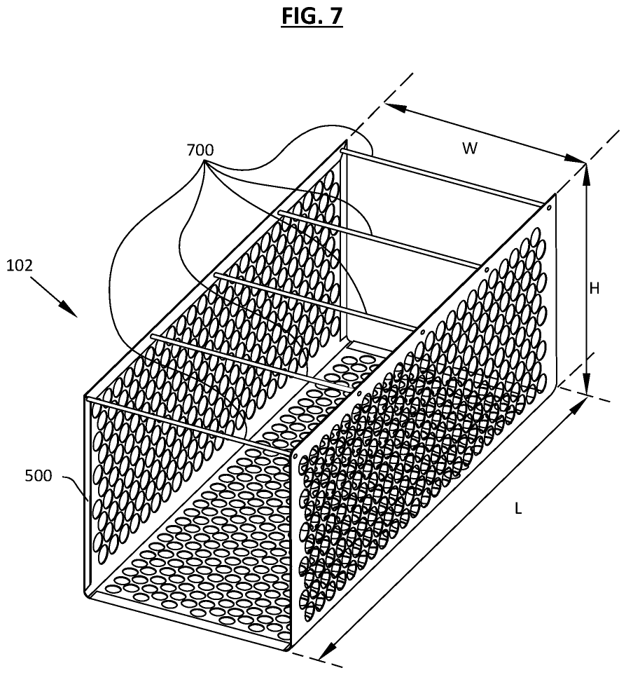

FIG. 7 shows an assembly of the frame 102 which uses a plurality of tubes or rods 700 attached to the top portion of the U-shaped structure 500 to provide structural support to maintain the shape of the frame 102. The framework of the structure 102 has a set of dimensions: height “H”, length “L”, and width “W”. The height H in some examples may be 333 mm, the length L in some examples may be 800 mm, and the width W in some examples may be 333 mm. In some examples, the height H, length L, and/or width W may be from 100 mm to 200 mm, from 200 mm to 300 mm, from 300 mm to 500 mm, from 500 mm to 700 mm, from 700 mm to 1 m, from 1 m to 1.5 m, from 1.5 m to 2 m, from 100 mm to 2 m, or any other suitable range there between, which may vary according to the various sizes and internal structures of the DAC reactor in which the DAC cartridges are to be installed.

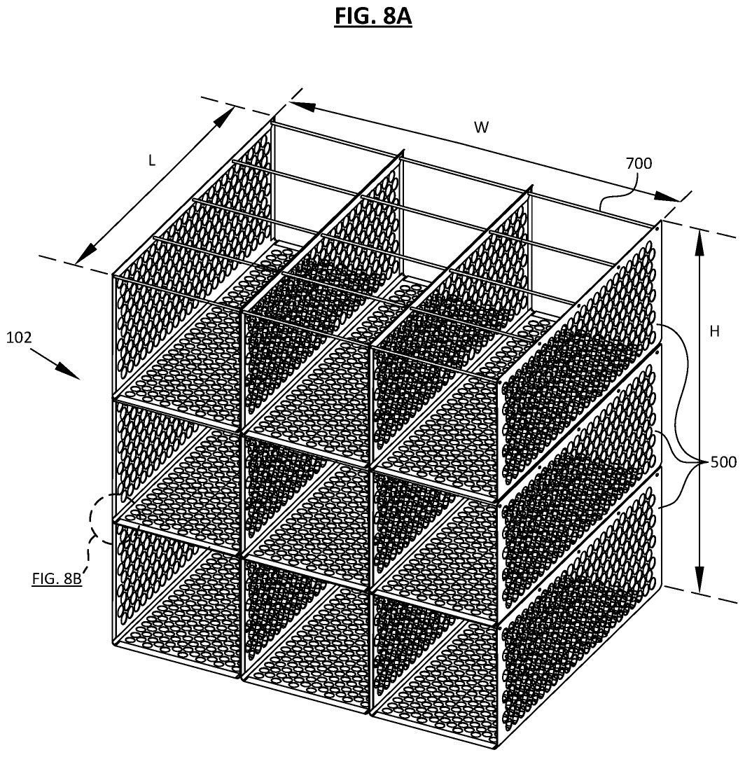

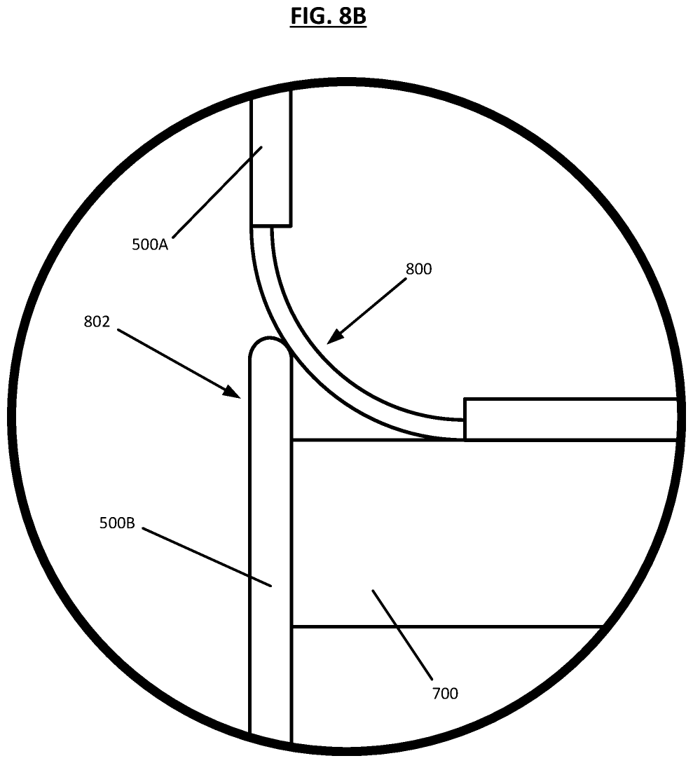

The rods 700 may be formed of the same material as the U-shaped structure 500 or a different material as suitable. The rods 700 are disposed to extend the entire width (W) of the U-shaped structure 500 at or near the top end so as to provide support for any cartridge which may be stacked on top of the frame 102 in a stacked configuration of DAC device 100. One example of the stacked configuration is shown in FIG. 8A with structures 500 stacked side-by-side along a width (W) direction of the structure and along a height (H) direction of the structure. In some examples (not shown), the structures may also be stacked side-by-side along a length (L) direction of the structure. The rods 700 may be removable to facilitate the assembly of the sorbent within the cartridge 101 or the assembly of the cartridge 101 within the structure 500. The rods 700 may be sufficiently solid or rigid so as to be capable of supporting one or more DAC cartridges 101 disposed on top of the rods 700 when implemented in the stacked configuration having multiple DAC cartridges 101 in a vertical orientation in the height (H) direction. The rods 700 may have a round (circular or ovular), rectangular, or polygonal cross-section, for example. Each of the rods 700 may have a maximal cross-sectional length of from 5 mm to 10 mm, from 10 mm to 15 mm, from 15 mm to 20 mm, from 20 mm to 25 mm, from 25 mm to 30 mm, from 30 mm to 35 mm, from 35 mm to 40 mm, or any other suitable value or range therebetween. Materials which may be used to form the rods 700 include but are not limited to carbon fiber, wood, plastic, and/or metal, such as aluminum and steel, for example.

FIG. 8A shows nine (9) frame structures 102 in a stacked configuration such that the bottom portion of the U-shaped structure 500 rests on the top portion of another U-shaped structure 500 disposed underneath, where the rods 700 extend from one end of the U-shaped structure 500 to the other end. In some examples, the height H may be 1 m, the length L may be 800 mm, and the width W may be 1 m, based on the example shown with respect to FIG. 7.

FIG. 8B shows that the U-shaped structure 500A has a rounded bottom corner 800 which rests on a top portion of the U-shaped structure 500B disposed beneath the structure 500A, such that a flanged upper lip 802 and the rods 700 of the bottom structure 500B supports the rounded bottom corner 800 of the top structure 500A to reduce misalignment of the two structures 500A and 500B with respect to each other in a vertical stack configuration. In some examples, the rounded bottom corner 800 of structure 500A has a curvature which couples with the flanged upper lip 802 and the rod 700 extending across the top portion of the structure 500B. In some examples, each of the U-shaped structures 500A and 500B may have the same structure for uniformity and positional interchangeability within a DAC device 100. In some examples, the rods 700 disposed across the top of the U-shaped structure 500 may defining a sliding engagement between the cartridge(s) 101 and the structure 500 to facilitate the sliding of cartridge(s) 101 in and out of the structure 500 and/or DAC reactor, for example after the multi-cartridge structure is installed inside the DAC reactor, while still providing structural support for the remaining cartridges 101.

In some examples, one or more engagement surfaces of the frame 102 may be defined at least partially by one or more of the wall(s) 108, the structure(s) 500, the rod(s) 700, and/or the corner(s) 800, as well as any components thereof. A first engagement surface of a first frame may form an engagement with a second engagement surface of a second frame such that the engagement therebetween may maintain a predetermined distance (PD1) between a first cartridge that is supported by the first frame and a second cartridge that is supported by the second frame. The first engagement surface may be disposed on the first frame to define a position of the second engagement surface when the second frame is engaging with the first frame.

Although first and second frames are referred to in the example above, it is to be understood that the frame may engage with a plurality of additional frames. For example, the first frame may include another/additional first engagement surface that is separate from the aforementioned first engagement surface, and a third frame may have a third engagement surface which engages with the another/additional first engagement surface of the first frame. The engagement maintains another predetermined distance (PD2) between the cartridges supported by first and third frames, where the another predetermined distance (PD2) may be the same as or different from the predetermined distance (PD1) that is maintained between the two cartridges supported by the first and second frames.

Furthermore, the first frame may include yet another/further additional first engagement surface that is separate from both the first engagement surface and the another/additional first engagement surface, and a fourth frame may have a fourth engagement surface such that the yet another/further additional first engagement surface of the first frame and the fourth engagement surface of the fourth frame may form an engagement with each other. The engagement maintains yet another predetermined distance (PD3) between the cartridges supported by first and fourth frames, where the yet another predetermined distance (PD3) may be the same as or different from the predetermined distance (PD1) that is maintained between the two cartridges supported by the first and second frames and/or the another predetermined distance (PD2) that is maintained between the two cartridges supported by the first and third frames.

For example, any one or more of the predetermined distances PD1, PD2, or PD3 may be zero or, alternatively, between zero and 1 mm, from 1 mm to 3 mm, from 3 mm to 5 mm, from 5 mm to 7 mm, from 7 mm to 1 cm, from 1 cm to 2 cm, from 2 cm to 3 cm, from 3 cm to 4 cm, from 4 cm to 5 cm, from 1 mm to 5 cm, or any other suitable value therebetween or combination of ranges thereof. The predetermined distances PD1, PD2, and PD3 may be measured between the outer surfaces of the respective components that define the engagement surfaces in question. For example, such surface may include an outer surface of a frame component, a wall, a U-shaped structure, a tube/rod, and/or a corner, etc. In some embodiments, the predetermined distances PD1, PD2, PD3 may be distances between respective cartridges supported by engaging frames, with the frames abutting each other. In other embodiments, the predetermined distances of corresponding cartridges may be identical to distances between portions of supporting frames associated with those cartridges. In still other embodiments, the predetermined distances may be greater than the distances between corresponding frames supporting the cartridges.

Beneficially, the cartridge design as disclosed herein allows for different structures, modular and configurable based on different requirements in a DAC reactor. The framework of each cartridge may beneficially provide support for sorbent material which may not be self-supporting. The cartridge design as disclosed herein also facilitates airflow, including crossflow if desired.

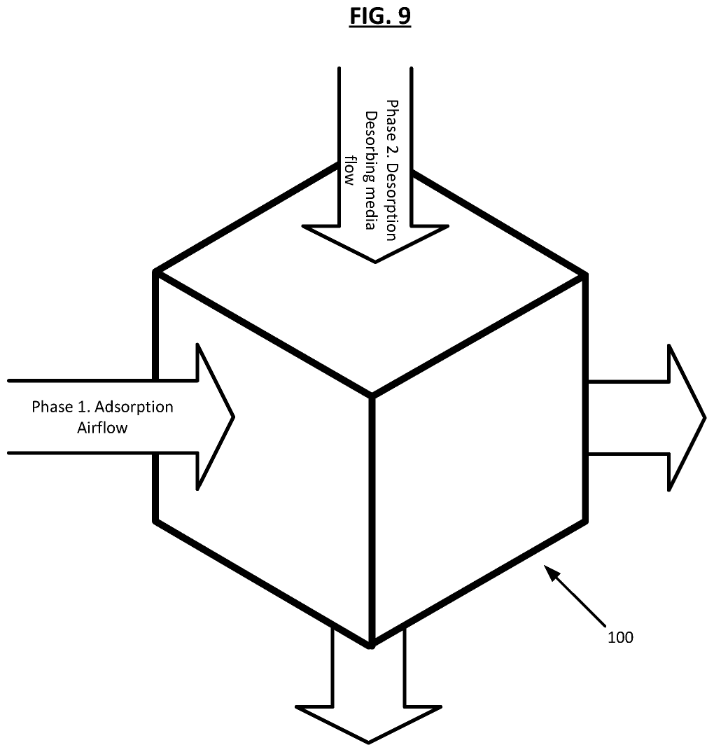

As shown in FIG. 9, crossflow of the DAC device 100 is defined by two phases. In a first adsorption phase (Phase 1), air passes into the cartridge that is filled with sorbent articles (sorbent assembly), which is shown as a cube in the figure, in a first direction as shown by the horizontal arrows. During Phase 1, carbon dioxide from the incoming air is captured inside the sorbent assembly. In a second desorption phase (Phase 2) which follows Phase 1, desorbing media passes into the cartridge in a second direction as shown by the vertical arrows. The vertical and horizontal directions are interchangeable. The cartridge or sorbent assembly may cycle between Phase 1 and Phase 2 such that the subsequent Phase 1 following Phase 2 may facilitate drying the sorbent assembly which may be moist or wet from the application of the desorbing media (e.g., steam) during Phase 2.

Beneficially, the cartridge design as disclosed herein may also facilitate ease of disassembly and replacement, ease of coating the sorbent material/articles inside the cartridge, which may encounter shrinkage, and/or ease of handling of the DAC device. Furthermore, the cartridge design is not predetermined to certain specific reactor design, such that different numbers, combinations, and configurations of cartridge may be implemented in the DAC reactor, as suitable or preferred by the user. In some examples, the benefits include reducing the size of the cartridge to improve manufacturability of the cartridges, and/or providing the capability of fitting different size reactors with additional flexibility/modularity in design.

### Carbon Dioxide Removal Service Providers

Also disclosed herein are methods for removing gaseous carbon dioxide (CO₂) from the atmosphere using any suitable means, methods, processes, or devices for atmospheric CO₂ removal as disclosed herein or as known in the art. In some examples, a carbon dioxide removal service provider that may be a person, a device, an atmospheric processing facility, a carbon dioxide removal plant, software, an internet site, an electronic interface, an organization, or a corporate agent or entity (that may include a control center, a headquarters, a data management center, an intermediary data collection or processing center, or facilitating organizations that provide information and/or control functions for or services to the provider) or an electronic device or display associated with or accessible to the provider may receive and/or become aware of information about a dispersion of a first quantity of gaseous CO₂ in the atmosphere at a first location. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. In some examples, the information may be in the form of an electronic communication (e.g., first electronic communication) that includes information about the dispersion of the first quantity of gaseous CO₂ into the atmosphere at the first location that may be received from and/or provided to a computing and/or electronic display device.

The carbon dioxide removal service provider may initiate an immediate or subsequent separating of or a method of separating a second quantity of gaseous CO₂ at a second location which may be different from the first location. The second location may be located remote to the first location such as, for example, when the first location is in a populated commercial area and the second location is near a geothermal or other hazardous energy source that powers the separating process at the second location. The second quantity may be at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. In some examples, the separating may be initiated by the sending or transmitting of instructions or confirmation to a location that has the capability of performing such separating. In some examples, the separating may be performed by a carbon capture device capable of carrying out any method for separating gaseous CO₂ from a gas mixture in the form of ambient air, as disclosed herein. In some examples, the distance from the first location to the second location may be from 100 km to 200 km, from 200 km to 500 km, from 500 km to 800 km, from 800 km to 1000 km, from 1000 km to 2000 km, from 2000 km to 3000 km, from 3000 km to 4000 km, from 4000 km to 5000 km, from 5000 km to 6000 km, from 6000 km to 7000 km, from 7000 km to 8000 km, from 8000 km to 9000 km, from 9000 km to 10,000 km, from 10,000 km to 15,000 km, from 15,000 km to 20,000 km, or any other suitable value or range therebetween.

The carbon dioxide removal service provider may initiate a reporting of data regarding the second quantity that will be, is being, or has been removed from the atmosphere. The initiating may be initial steps taken to start an immediate or subsequent reporting of data that may be performed via any suitable means of electronic communication or data transmission which may be wired or wireless. In some examples, the reporting may involve the preparing of information to be included in such reporting or later reporting and the subsequent sending or transmitting of instructions or confirmation to another entity or device which has the capability of starting or fully performing such reporting. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication may be transmitted to the computing or display device. In some examples, the second electronic communication may be transmitted to an additional computing or display device that may be separate or different from the aforementioned computing or display device.

In some examples, the method for removing gaseous CO₂ from the atmosphere may involve a carbon dioxide removal service provider (as described above) that may receive and/or become aware of information about a first quantity of gaseous CO₂ which may include a dispersion of gaseous CO₂. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. Such quantity may represent the amount of gaseous CO₂ being dispersed at a location (e.g., in tons of CO₂) and/or the rate of dispersion (e.g., in tons of CO₂ per minute, hour, day, etc.). In some examples, the information may be received as an electronic communication from another entity or device which sends or transmits instructions concerning gaseous CO₂ removal as disclosed herein. In some examples, an electronic communication (e.g., first electronic communication) that includes information about the dispersion of the first quantity of gaseous CO₂ that may be received from and/or provided to a computing and/or electronic display device.

The carbon dioxide removal service provider may separate or begin separation of a second quantity of gaseous CO₂ from the atmosphere, where the second quantity is at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. In some examples, the separating may be performed by a carbon capture device capable of carrying out any method for separating gaseous CO₂ from a gas mixture in the form of ambient air, as disclosed herein.

The carbon dioxide removal service provider may report the data regarding the second quantity that will be, is being, or has been removed from the atmosphere. The reporting of data may be performed via any suitable means of electronic communication or data transmission which may be wired or wireless. In some examples, the reporting may be in response to receiving instructions or confirmation as transmitted from another entity or device which has the capability of starting or fully performing such reporting. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication may be transmitted to the computing or display device. In some examples, the second electronic communication may be transmitted to an additional computing or display device that may be separate or different from the aforementioned computing or display device.

In some examples, the method for removing gaseous CO₂ from the atmosphere may involve a carbon dioxide removal service provider (as described above) that may transmit, emit, or send out information about a dispersion of a first quantity of gaseous CO₂ into the atmosphere at a first location. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. The transmitting may be an emitting and/or a sending out performed via any suitable means of electronic communication or data transmission which may be wired or wireless that may not be received by the intended recipient or any recipient. In some examples, the information may be in the form of an electronic communication (e.g., first electronic communication) that includes information about the dispersion of the first quantity of gaseous CO₂ into the atmosphere at the first location that may be transmitted, emitted, and/or sent out to a computing device with such transmission, emitting, and/or sending out not necessarily being received by any recipient.

The carbon dioxide removal service provider may request an immediate or subsequent separating of or a method of separating a second quantity of gaseous CO₂ from the atmosphere at a second location. The second location may be located remote to the first location such as, for example, when the first location is in a populated commercial or industrial area and the second location is near a geothermal or other hazardous energy source that powers the separating process at the second location. The second quantity may be at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. The requesting of the separating or an initiation of the separating may be performed via any suitable means of electronic communication or data transmission which may be wired or wireless. In some examples, the requesting may be by sending, emitting, or transmitting of instructions to a start command to a location that has the capability of starting or fully performing such separating. In some examples, the separating may be performed by a carbon capture device capable of carrying out any method for separating gaseous CO₂ from a gas mixture in the form of ambient air, as disclosed herein. In some examples, the distance from the first location to the second location may be from 100 km to 200 km, from 200 km to 500 km, from 500 km to 800 km, from 800 km to 1000 km, from 1000 km to 2000 km, from 2000 km to 3000 km, from 3000 km to 4000 km, from 4000 km to 5000 km, from 5000 km to 6000 km, from 6000 km to 7000 km, from 7000 km to 8000 km, from 8000 km to 9000 km, from 9000 km to 10,000 km, from 10,000 km to 15,000 km, from 15,000 km to 20,000 km, or any other suitable value or range therebetween.

The carbon dioxide removal service provider may receive a reporting, an indication of such reporting, and/or an indication of an availability of data regarding the second quantity that will be, is being, or has been removed from the atmosphere. The receiving of the reporting does not require examination or review by a human, may be achieved by simply making the reporting accessible even if subsequently never reviewed or acknowledged, and/or may be performed via any suitable means of electronic communication or data transmission which may be wired or wireless. In some examples, the receiving of the reporting may regard the second quantity, such as how much of the gaseous CO₂ was separated within a predetermined amount of time, for example within a day, a week, a month, etc. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication is received from the computing device. In some examples, the second electronic communication is received in response to the transmitting of the first electronic communication. In some examples, the second electronic communication is received from the computing or display device in response to the transmitting of the first electronic communication to the computing or display device.

As used herein, “receiving” information is to be understood as an act of “receiving” which requires only one party (or entity, device, etc.) to perform, such that a separate party for performing the act of “sending” is not required.

As used herein, “initiating” a separating (or a method of separating) is to be understood as an act of “initiating” that includes an initial or completed act of preparing or dispatching instructions to another party or device with the intent that there is an execution or start of a separating process or the association of an already started separating process with the initiating step. For example, the act of “initiating” the separating of gaseous CO₂ may cause a carbon capture device to subsequently receive an instruction, either directly or indirectly (e.g., via intermediary entities or devices) to initiate the separating, in response to which the carbon capture device operates accordingly. In another example, the act of “initiating” a separating (or a method of separating) gaseous CO₂ may include a carbon dioxide removal service provider associating carbon dioxide that has already been removed from the atmosphere (or presently in an active removal process) with a subsequent initiating of a separating. It will be appreciated that the instruction received by the carbon capture device need not be provided as part of such an “initiating” operation. Further, the act of “separating” of the CO₂, for example, is therefore not necessarily part of the act of “initiating” such separating, such as when the “initiating” of the separating is performed by a first party and the subsequent “separating” itself is performed by a second party different from the first party. Furthermore, the act of “separating” does not need to be accomplished or fully completed, either by the first party or the second party. It will also be appreciated that the act of initiating can be fully performed in one jurisdiction or country even though an acknowledgement of the initiating or an act subsequent to or associated with the initiating takes place in a different jurisdiction or country.

As used herein, “initiating” a reporting (e.g., of data) is to be understood as an act of “initiating” that includes the initial or complete act of preparing or dispatching instructions to another party to prepare, start, or complete the reporting at a later time. The act of “reporting” any data, for example, is therefore not necessarily part of the act of “initiating” such reporting, such as when the “initiating” of the reporting is performed by a first party (the initiating party) and the “reporting” itself is performed by a second party (the reporting party) different from the first party (the initiating party). Furthermore, the act of “reporting” does not need to be accomplished or fully completed, either by the first party or the second party. It will be appreciated that the act of initiating can be fully performed in one jurisdiction or country even though an acknowledgement of the initiating or an act subsequent to or associated with the initiating takes place in a different jurisdiction or country.

As used herein, “reporting” data is to be understood as an act of “reporting” which may require only one party (reporting party) to perform. Furthermore, the act of “reporting” does not require the receipt (or confirmation of receipt) of such reporting by another party (receiving party). The reporting may be a storage of the data or display of the data at a location that is accessible to an intended recipient, and may still be considered to be a reporting even when the intended recipient does not access or review the data.

As used herein, “transmitting” information is to be understood as an act of “transmitting” which may require only one party (the transmitting party) to perform. Furthermore, the act of “transmitting” does not require a receiver (e.g., receiving party) or receipt (e.g., confirmation of receipt) of the information that is transmitted.

As used herein, “requesting” a separating (or initiation of a method of separating) is to be understood as an act of “requesting” which may require only one party (the requesting party) to perform. Also, the act of “separating” which is requested by the act of “requesting” may be performed by another party (the separating party). Furthermore, the act of “requesting” may be only intended or started and does not need to be accomplished or fully completed (e.g., when no separating results from the act of “requesting” such separating). In an example, the act of “requesting” a separating (or initiation of a method of separating) of gaseous CO₂ may include a carbon dioxide removal service provider associating carbon dioxide that has already been removed from the atmosphere (or presently in an active removal process) with a subsequent request for a separating. It will be appreciated that the act of requesting can be fully performed in one jurisdiction or country even though an acknowledgement of the requesting or an act subsequent to or associated with the requesting takes place in a different jurisdiction or country.

As used herein, “receiving” a reporting or an indication of the reporting is to be understood as an act of “receiving” which does not require a sender (e.g., sending party). The receiving may be a storage of the data or display of the data at a location that is accessible to an intended recipient, and may still be considered to be a receiving even when the intended recipient does not access or review the data.

As can be appreciated, the first quantity, the second quantity, and the portion of the first quantity may be estimated or projected values. It can be further appreciated that carbon dioxide gas released or dispersed at the first location may not necessarily include or be the same CO₂ molecules separated or collected at the second location, and that the second quality may be an equivalent quantity of CO₂ that was released or dispersed. The CO₂ in the portion of the first quantity may be in a non-gaseous form. The portion of the first quantity or the second quantity may refer to carbon dioxide that is entrapped in the sorbent as disclosed herein or that has been stored or otherwise converted into another form. The portion of the first quantity or the second quantity may also include gases other than carbon dioxide. For example, the second quantity may be in a non-gaseous form or combined with other materials.

As used herein, a “carbon capture device” refers to any one or more devices as disclosed herein that is capable of separating gaseous CO₂ from the atmosphere at the location at which the device is installed or located. The carbon capture device may refer to a single device or a plurality of devices, or a facility containing therein one or more such devices or component devices that act in concert. The device may include, for example, the desorbing media source(s) and the adsorber structure(s) as disclosed herein. The device may be operable by a user or operator using an electronic device. The device may generate data associated with its operation, for example as may be detected by one or more sensors and/or as may include log data, among other examples.

As used herein, an “electronic device” is capable of performing one or more electronic operations, for example a computer, smartphone, smart tablet, etc. The electronic device may include for example a display device and/or one or more processing units and one or more memory units. The processing unit may include a central processing unit (CPU), a microprocessor, system on a chip (SoC), or any other processor capable of performing such operations. The memory unit may by a non-transitory computer-readable storage medium storing one or more programs or instructions thereon which, when run on the processing unit, causes the processing unit or the electronic device to perform one or more methods as disclosed herein. The memory unit may include one or more memory chips capable of storing data and allowing storage location to be accessed by the processing unit(s), for example a volatile or non-volatile memory, static or dynamic random-access memory, or any variant thereof. In some examples, the electronic device may be referred to as a computing device.

Technical advantages of removing gaseous CO₂ from an atmosphere using the methods or processes as disclosed herein includes, but are not limited to, facilitating a network of entities and/or devices that are capable of communicating with other entities and/or devices in order to remotely provide instructions or facilitating separation and removal of gaseous CO₂ without requiring to be physically at the location to do so. Furthermore, the methods and processes as disclosed herein provide a robust network of interinstitutional communication such that each entity (which may be an institution associated with a physical location) is capable of directing or initiating the separation and removal of gaseous CO₂ at multiple locations simultaneously, as well as having the capability of flexibly changing the location at which separation and removal of gaseous CO₂ is determined to be removed. The change in location may be performed at or near real-time such that there is minimal time lag between when the instructions are provided and when the separating of gaseous CO₂ takes place at the designated location, for example. In some examples, the methods or processes as disclosed herein provides a flexible communication network in which the entity or device which performs the separation and removal of gaseous CO₂ at the designated location may provide a timely reporting (e.g., operation summary and/or invoice for the service rendered) associated with the amount of gaseous CO₂ that was removed during a predetermined time period. Such reporting may be generated automatically or manually, may be generated at a predetermined time interval (e.g., once every day, week, month, etc.) or more flexibly as manually determined (e.g., each time a user or entity requests), or may be generated in response to achieving or exceeding a predetermined threshold, including but not limited to the amount of gaseous CO₂ that was separated and removed from the atmosphere (e.g., every 1 ton, 5 tons, 10 tons, etc., of gaseous CO₂ that was removed from the atmosphere), and any other suitable conditions as determined and agreed upon by the entities involved, for example.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A direct air capture (DAC) device comprising:
a first removable cartridge; and
a first frame supporting the first removable cartridge and defining a first engagement surface of the first frame, the first engagement surface being disposed on the first frame to define a position of a second engagement surface of a second frame when the second engagement surface is disposed to engage the first engagement surface,
wherein the engagement between the first and second engagement surfaces maintains a predetermined distance between the first removable cartridge and a second removable cartridge supported by the second frame.

2. The device of claim 1, further comprising:
the second removable cartridge; and
the second frame supporting the second removable cartridge and defining the second engagement surface that is disposed to engage the first engagement surface of the first frame to maintain the predetermined distance between the first removable cartridge and the second removable cartridge supported by the second frame.

3. A direct air capture (DAC) device comprising:
a first frame defining a first engagement surface of the first frame, the first frame configured to support a first cartridge;
a second frame defining a second engagement surface of the second frame, the second frame configured to support a second cartridge,
wherein the first and second engagement surfaces, when engaged with each other, maintain a predetermined distance between the first and second cartridges.

4. The device of claim 3, wherein the first or second frame is configured to support the first or second cartridge by providing at least one of:
(a) a frame rail upon which an edge surface of the first or second cartridge rests,
(b) a frame channel through which a projection of the first or second cartridge is disposed, and
(c) a frame surface that is disposed to support the weight of the first or second cartridge.

5. The device of claim 3, further comprising:
the first cartridge removably disposed in the first frame; and
the second cartridge removably disposed in the second frame.

6. The device of claim 3, further comprising a plurality of walls supported by the first frame to define at least an interior of the first frame.

7. The device of claim 3, wherein the first frame defines another first engagement surface of the first frame, the device further comprising:
a third frame defining a third engagement surface and configured to support a third cartridge,
wherein the third engagement surface and the another first engagement surface, when engaged with each other, maintain another predetermined distance between the first and third cartridges.

8. The device of claim 7, wherein the third frame is configured to support the third cartridge by providing at least one of:
(a) a frame rail upon which an edge surface of the third cartridge rests,
(b) a frame channel through which a projection of the third cartridge is disposed, and
(c) a frame surface that is disposed to support the weight of the third cartridge.

9. The device of claim 7, further comprising:
the third cartridge removably disposed in the third frame.

10. The device of claim 7, wherein the another predetermined distance is the same as the predetermined distance.

11. The device of claim 7, wherein the first frame defines yet another first engagement surface of the first frame, the device further comprising:
a fourth frame defining a fourth engagement surface and configured to support a fourth cartridge,
wherein the fourth engagement surface and the yet another first engagement surface,
when engaged with each other, maintain yet another predetermined distance between the first and fourth cartridges.

12. The device of claim 11, wherein the fourth frame is configured to support the fourth cartridge by providing at least one of:
(a) a frame rail upon which an edge surface of the fourth cartridge rests,
(b) a frame channel through which a projection of the fourth cartridge is disposed, and
(c) a frame surface that is disposed to support the weight of the fourth cartridge.

13. The device of claim 11, further comprising:
the fourth cartridge removably disposed in the fourth frame.

14. The device of claim 11, wherein the yet another predetermined distance is the same as one or more of the predetermined distance or the another predetermined distance.

15. A direct air capture (DAC) device comprising:
a first cartridge; and
a first frame having opposing walls defining a first cartridge compartment disposed between the opposing walls, each opposing wall including a sliding surface facing the first cartridge compartment,
wherein the first cartridge is slidably disposed within the first cartridge compartment.

16. A direct air capture (DAC) device comprising:
a first frame having first opposing walls defining a first cartridge compartment disposed between the first opposing walls, the first opposing walls having internal surfaces defining a slidable engagement configured to support a first cartridge in the first cartridge compartment; and
a second frame having second opposing walls defining a second cartridge compartment disposed between the second opposing walls, the second opposing walls having internal surfaces defining a slidable engagement configured to support a second cartridge in the second cartridge compartment,
wherein the first and second frames, when engaged with each other, maintain a predetermined distance between the first and second cartridges.

17. The device of claim 16, wherein the first or second frame is configured to support the first or second cartridge by providing at least one of:
(a) a frame rail upon which an edge surface of the first or second cartridge rests,
(b) a frame channel through which a projection of the first or second cartridge is disposed, and
(c) a frame surface that is disposed to support the weight of the first or second cartridge.

18. The device of claim 16, further comprising:
the first cartridge removably disposed in the first cartridge compartment of the first frame; and
the second cartridge removably disposed in the second cartridge compartment of the second frame.

19. The device of claim 16, further comprising:
a third frame having third opposing walls defining a third cartridge compartment disposed between the third opposing walls, the third opposing walls having internal surfaces defining a slidable engagement configured to support a third cartridge in the third cartridge compartment.

20. The device of claim 19, wherein the third frame is configured to support the third cartridge by providing at least one of:
(a) a frame rail upon which an edge surface of the third cartridge rests,
(b) a frame channel through which a projection of the third cartridge is disposed, and
(c) a frame surface that is disposed to support the weight of the third cartridge.

21. The device of claim 19, further comprising:
the third cartridge removably disposed in the third cartridge compartment of the third frame,
wherein the first and third frames, when engaged with each other, maintain another predetermined distance between the first and third cartridges.

22. The device of claim 21, wherein the another predetermined distance is the same as the predetermined distance.

23. The device of claim 21, further comprising:
a fourth frame having fourth opposing walls defining a fourth cartridge compartment disposed between the fourth opposing walls, the fourth opposing walls having internal surfaces defining a slidable engagement configured to support a fourth cartridge in the fourth cartridge compartment; and
the fourth cartridge removably disposed in the fourth cartridge compartment of the fourth frame,
wherein the first and fourth frames, when engaged with each other, maintain yet another predetermined distance between the first and fourth cartridges.

24. The device of claim 23, wherein the fourth frame is configured to support the fourth cartridge by providing at least one of:
(a) a frame rail upon which an edge surface of the fourth cartridge rests,
(b) a frame channel through which a projection of the fourth cartridge is disposed, and
(c) a frame surface that is disposed to support the weight of the fourth cartridge.

25. The device of claim 23, wherein the yet another predetermined distance is the same as one or more of the predetermined distance or the another predetermined distance.
